(19) United States
(12) Patent Application Publication
(10) Pub. No.: US 2006/0289126 A1
(43) Pub. Date: Dec. 28, 2006

(54) End cap and container for venetian blinds

(76) Inventors: Michael Kollman, Madison, WI (US); Adam Ward, Madison, WI (US)

Correspondence Address: BUCHANAN INGERSOLL & ROONEY PC, P.O. BOX 1404, ALEXANDRIA, VA, 22313-1404, US

(21) Appl. No.: 11/167,825

(22) Filed: Jun. 27, 2005

(51) Int. Cl. E06B 9/00

(52) U.S. Cl. 160/178.1 R

(57) ABSTRACT

An end cap for tubular containers of the type used to hold a venetian blind has a cavity of sufficient size to hold window covering hardware shipped with the blinds. The end cap preferably has a housing having a base, a first wall connected to the base by a first hinge and a second wall, substantially parallel to the first wall and connected to the base by a second hinge. A cover is removably attached to the housing and configured so that the first wall of the housing may pivot about the first hinge and the second wall of the housing may pivot about the second hinge while the cover is attached to the housing. The first wall, base, and second wall of the housing and the cover preferably define a parallelogram whose shape can change as the end cap is removed from a tubular container into which the end cap has been inserted.

### FIELD OF THE INVENTION

The invention relates to an end cap for a container for storing and trimming window blinds in which the blind can be trimmed to a desired length without removing the blind from the container.

### BACKGROUND OF THE INVENTION

Window blinds are an attractive and popular window covering used by many for both residential and commercial purposes. Horizontal, or venetian blinds, consist of numerous slats hung on ladders that extend between a headrail and a bottomrail. These blinds can be custom made by the blind manufacturer or fabricator. Alternatively, the blinds can be sold through home centers and other retail outlets that buy the blinds in standard sizes and then trim the blinds as necessary to fit the windows of their customers. These stock blinds are individually packaged in boxes and shipped to retail outlets.

In the retail outlets customers can choose the type of blind they prefer. If the measurements of the window on which the blind will be hung do not correspond to a stock size, a stock blind that is larger than the window is selected, removed from its box and trimmed. Removing the blind from its packaging and then replacing the blind after trimming is time consuming for the retailer. Because of the numerous slats and the flexible nature of the blinds they can be awkward to work with and can be damaged during the trimming and repackaging process.

The same box that holds the venetian blind usually contains hardware such as mounting brackets, screws and hold down brackets that are to be connected to the blind when the blind is installed. This hardware is usually loose in the box and may be in one or more bags. When the blind is cut down in the store this hardware may fall out of the box. Should this occur without notice by the customer or sales associate, the buyer will leave the store without the hardware needed to install the blind. Upon discovery that pieces are missing the buyer will return the blind to the store and may demand and receive an entirely new blind. Consequently, there is a need for a container in which this hardware is securely held to prevent loss during the cut-down process.

U.S. Pat. No. 6,793,073 to Tu discloses a window blind container formed by a rectangular box with removable ends. After the ends are removed, portions of the blind are exposed and can be trimmed without removing the blind from the box. U.S. Pat. No. 3,521,810 to Boyer describes a rectangular telescoping box to hold elongated articles. These containers do not have a structure that will retain the blind hardware.

There is a need for a container for venetian type blinds which has a portion that will retain the blind hardware and prevent that hardware from being lost when the blind is being trimmed. This container should allow a blind to be trimmed without removing the blind from the container. Preferably, a single container could be used for more than one stock blind size. This container should have a cavity that will hold the blind hardware and that will remain attached to the container while the blind is being trimmed. The container should be made of a clear plastic so that the retailer and the buyer can easily view the blind that is inside the container without removing the blind from the package. Finally, the container should enable the blind to be cut down without removing the blind from the box.

### SUMMARY OF THE INVENTION

We provide an end cap and tubular container having such end cap at either or both ends. The end cap has a housing and a cover. When assembled the housing and cover define a cavity of sufficient size to hold window covering hardware of the type that is shipped with but not attached to a window blind. A preferred housing has a base, a first wall connected to the base by a first hinge and a second wall, substantially parallel to the first wall and connected to the base by a second hinge. The housing may be U-shaped. Any of the base and walls of the housing may be curved. A cover is removably attached to the housing and configured so that the first wall of the housing may pivot about the first hinge and the second wall of the housing may pivot about the second hinge while the cover is attached to the housing.

Preferably the cover has a flat base and two substantially parallel walls that extend from the base. We prefer to provide arms on the first wall and second wall of the housing that fit within slots in the parallel walls of the cover. This arrangement enables the first wall and second wall of the housing to pivot relative to the base of the cover.

When the cover is attached to the housing, the housing and cover define a cavity encircled by a parallelogram. Because the side walls of the housing can pivot relative to the base of the housing and relative to the base of the cover, the shape of the parallelogram can change. This ability enables the end cap to be removed from a tubular container while keeping one side wall of the housing in close proximity to the container during and after removal of the end cap from the container.

The container preferably has a tubular body having a first open end and a second open end and a pair of flat sidewalls that are parallel to one another. One end cap is removably inserted into and covers the first open end of the tubular body and a second end cap is removably inserted into and covers the second open end of the tubular body. We further prefer that the tubular body be telescoping so that a blind in the container can be trimmed without removing the blind from the container. If the housing of the end cap has a flat base, the window covering may press against that flat base during the trimming process. Then the end being trimmed will be held straight.

Other objects and advantages of the present container will become apparent from certain present preferred embodiments thereof that are shown in the drawings.

### BRIEF DESCRIPTION OF THE DRAWINGS

FIG. 1 is a perspective view of a first present preferred embodiment of our end cap.

FIG. 2 is a perspective view of the housing that forms a portion of the end cap shown in FIG. 1.

FIG. 3 is a perspective view of the cover portion of the end cap shown in FIG. 1.

FIG. 4 is a side view of one end of a container into which the end cap shown in FIG. 1 is fully inserted.

FIG. 5 is a side view similar to FIG. 4 showing the end cap partially removed.

FIGS. 6, 7, 8 are side views similar to FIGS. 4 and 5 progressively showing the end cap as it is removed from the container.

FIG. 9 is a side view similar to FIGS. 4 through 8 showing the end cap fully removed and pivoted away from the end of the container.

FIG. 10 is a prospective view of a second present preferred embodiment of our end cap.

### DETAILED DESCRIPTION OF THE PREFERRED EMBODIMENTS

A first present preferred embodiment of our end cap 1 has a U-shaped housing 2 to which a cover 4 is removably attached. The housing 2 has a base 3 and two parallel side walls 5, 7 attached to either end of the base by a hinge 6, 8. We prefer to make the housing of a plastic such as polyvinyl chloride or polycarbonate and to mold the part so that the hinges 6, 8 are living hinges. We also prefer to provide reinforcing ribs 13 along the base 3. The side walls 5, 7 are molded to have a lip 9 that will abut an edge of a container 20, when the end cap is fully inserted into the container shown in FIG. 4. Arms 10 extend from opposite sides of each side wall near the lip. These arms fit into slots 11 provided in the cover 4 allowing the side walls 5, 7 to pivot about the arms. The cover 4 has a base 12 and two parallel side walls 14 and 15. The upper edges of the side walls preferably are curved or peaked to allow easy insertion of the cover 4 into the housing 2. When the cover and housing are attached they define a cavity 16 which is of sufficient size to hold hardware for a venetian blind or other window covering. Typically that hardware will include mounting brackets, hold down brackets and screws. The cover 4 is also preferably a molded plastic such as polyvinylchloride or polycarbonate. If desired, either or both of the cover and U-shaped housing could be metal.

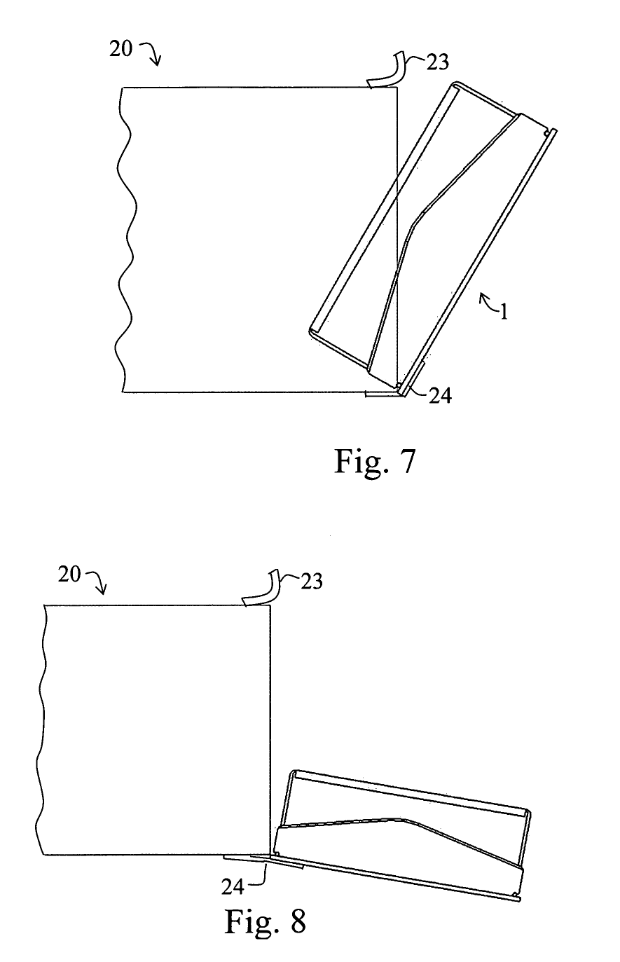

The hinges 6, 8 in the housing 2 and the pivoting connection of the side walls 5 and 7 to the cover 4 create a parallelogram that can change shape. That is, the angle between each side wall 5, 7 and the base 3 of the housing 2 and the angles between each side wall and the base 12 of the cover 4 can be changed while the housing is fully assembled. This structure enables the container to be opened while maintaining the end cap in close proximity to the container as shown in FIGS. 4 through 7.

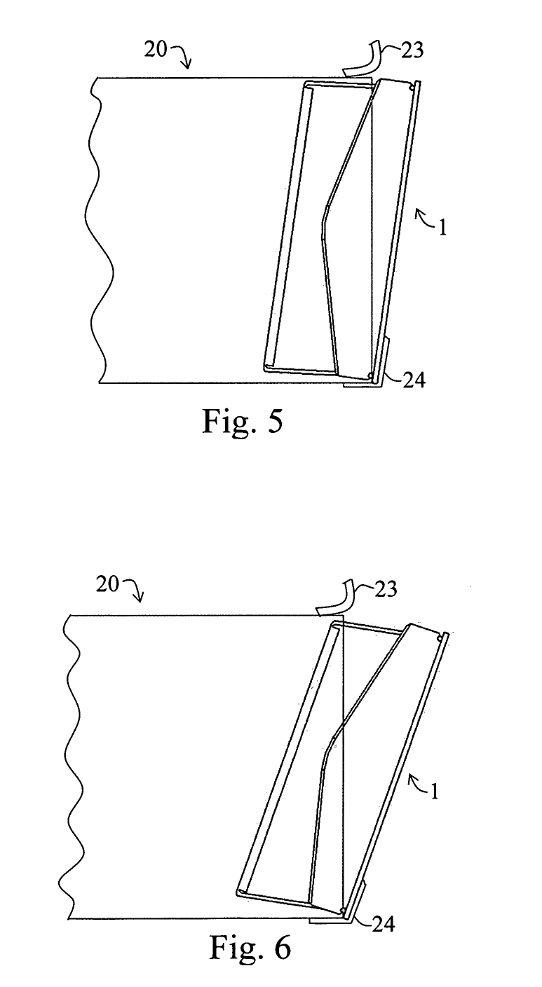

The sequence of opening the container begins with the end cap 1 fully inserted into a tubular container 20 as shown in FIG. 4. This container 20 has four side walls 21 such that two side walls are opposite the side walls 5, 7 of the housing 2 and two side walls are opposite the side walls 14, 15 of the cover 4. Preferably, the container is made of clear flexible plastic and the same end cap 1 is on each end of the container. Strips of adhesive tape 23, 24 are attached between the end cap 1 and cover 4 such that one strip is opposite each side wall 5, 7 of the housing. To remove the end cap the user removes one strip of tape 23 from the end cap and pulls the end cap at a location near where the strip of tape had been attached to the cover. This pulling motion is indicated by arrow 25 in FIG. 5. Pulling the end cap at that location causes the side walls 5, 7 of the housing to pivot relative to the base of the housing and the cover. Continued pulling removes the end cap from the opening in the container while the second strip of tape 24 remains in place. As a result the tape will keep the end cap in close proximity to the container while the container is fully open. Then, the sales associate may pull the end of a blind (not shown) that is within the container from the container and place the blind (now partially within the container) in a cut down machine. After one end of the blind is trimmed the blind is fully inserted into the container and the end cap is replaced. This procedure is then repeated for the opposite end of the blind and container. If the container is a telescoping tubular structure and the housing of the end cap has a flat base, such as base 3, the window covering may press against that flat base during the trimming process. Then the end being trimmed will be held straight.

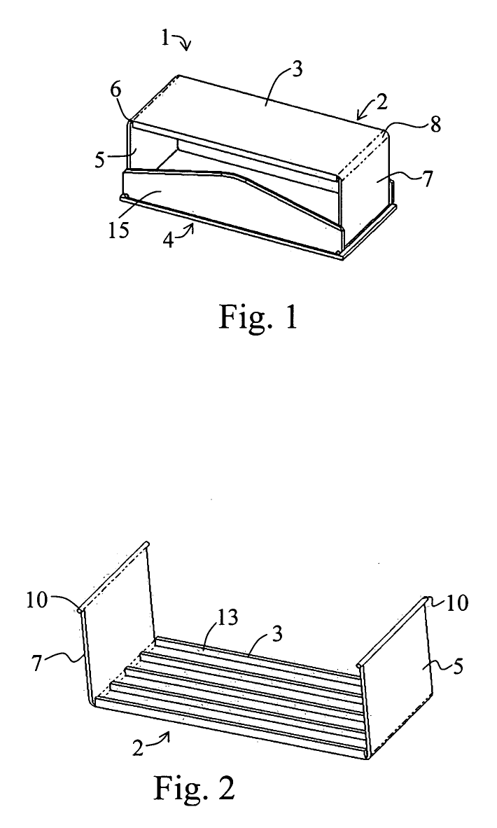

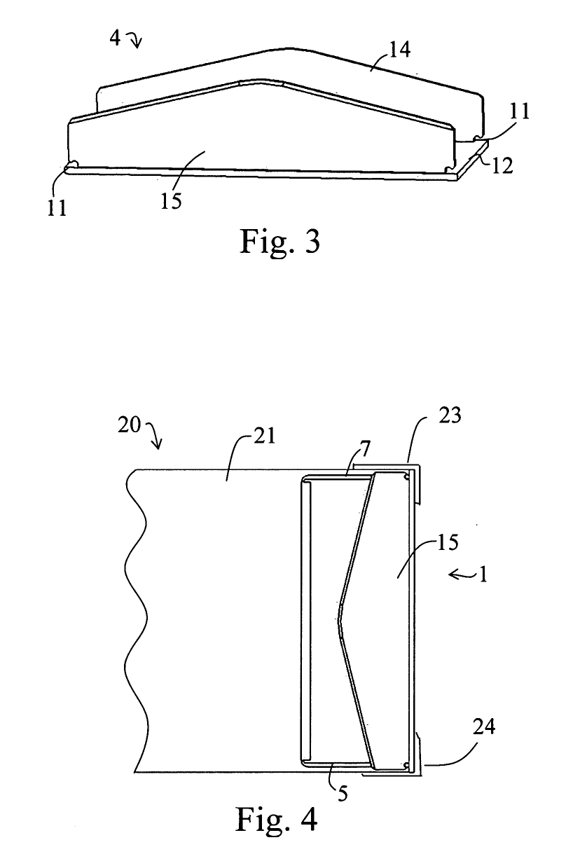

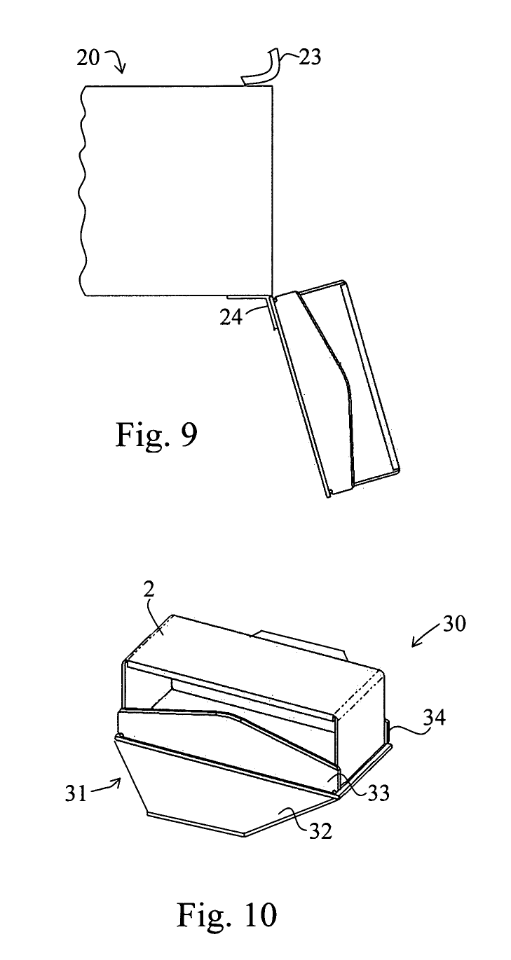

Although the preferred end cap is rectangular, the end cap could be any shape provided there are two parallel side walls pivotably attached to a base and pivotably attached to the cover. Moreover, the shape of the end cap must enable these side walls to pivot as in the embodiment shown in FIGS. 1 through 9.

A second present preferred end cap 30 that fits into a container having an octagonal cross section is shown in FIG. 10. This end cap utilizes the same U-shaped housing 2. The cover 31 has an octagonal base 32 that corresponds to the cross section of the container (not shown) to which it will be attached. A pair of spaced-apart, parallel, side walls 33, 34 extends from the base 32. They are positioned so that the arms 10 that extend from side walls 5, 7 of the housing 2 will fit into slots in walls 33 and 34. This end cap 30 can be inserted into a container having an octagonal cross-section in a manner so that sides 5, 7 will be adjacent two opposite sides of the hexagonal container. Then the end cap can be removed from the container in the same manner as the first embodiment.

Other variations of the present invention can be made by simply changing the shape of the base 32 or cover 31 while attaching the same or similar U-shaped housing to the cover. Should the container have a shape in which there are no parallel side walls, an insert or inserts could be attached to that container to provide two spaced apart parallel walls. These walls would be positioned such that the side walls 5, 7 of the U-shaped housing 2 would be opposite those side walls when the end cap is placed on the container.

The present end cap and container allow a blind to be shipped from the manufacturer, stored, trimmed and carried away from the retailer by the purchaser without removing the blind from the package and without separating the blind hardware from the package. Although the container is particularly useful for venetian blinds, the container could be used for other types of window coverings including vertical blinds, pleated and cellular shades, roll up shades and roller shades. Moreover, other types of products could be packaged in containers having the end caps here disclosed.

While the invention has been described in conjunction with specific embodiments thereof, the invention is not limited thereto, but may be variously embodied within the scope of the following claims.

We claim:

1. An end cap comprising:
a housing having a base, a first wall connected to the base by a first hinge and a second wall, substantially parallel to the first wall and connected to the base by a second hinge; and
a cover removably attached to the housing and configured so that the first wall of the housing may pivot about the first hinge and the second wall of the housing may pivot about the second hinge while the cover is attached to the housing.

2. The end cap of claim 1 also comprising a pair of substantially parallel side walls extending from the cover and toward the housing.

3. The end cap of claim 1 wherein at least one of the housing and the cover is comprised of a material selected from the group consisting of polyvinyl chloride, polycarbonate, and metal.

4. The end cap of claim 1 wherein the first hinge and the second hinge are living hinges.

5. The end cap of claim 1 also comprising a plurality of ribs attached to the base of the housing.

6. The end cap of claim 1 wherein the cover is comprised of a base having two spaced apart side walls and wherein a pair of arms are provided in each of the first wall and the second wall and the spaced apart sidewalls each have a pair of slots, one slot of each side wall containing an arm on the first wall and the second slot on each side wall containing an arm on the second wall.

7. The end cap of claim 1 wherein the housing and the cover together define a cavity of sufficient size to hold window covering hardware of the type that is shipped with but not attached to a window blind.

8. The end cap of claim 1 wherein the housing is U-shaped.

9. The end cap of claim 1 wherein the base is flat.

10. An end cap comprising a housing and a cover removably attached to the housing, the housing and cover configured to fit onto an end of a tubular container and to define a cavity of sufficient size to hold window covering hardware of the type that is shipped with but not attached to a window blind.

11. The end cap of claim 10 wherein at least one of the housing and the cover is comprised of a material selected from the group consisting of polyvinyl chloride, polycarbonate and metal.

12. A container having removable end caps comprising:
a tubular body having a first open end and a second open end and a pair of flat sidewalls that are parallel to one another;
a first end cap removably inserted into and covering the first open end of the tubular body;
a second end cap removably inserted into and covering the second open end of the tubular body;
wherein at least one of the first end cap and the second end cap is comprised of:
a housing having a base,
a first wall attached to the base by a first hinge and a second wall attached to the base by a second hinge, the first wall and the second wall being substantially parallel to one another and also being substantially parallel to the pair of flat side walls of the tubular body when the housing is inserted into the tubular body; and
a cover removably attached to the housing and configured so that the first wall of the housing may pivot about the first hinge and the second wall of the housing may pivot about the second hinge while the cover is attached to the housing.

13. The container of claim 12 also comprising a pair of substantially parallel side walls extending from the cover and toward the housing.

14. The container of claim 12 wherein at least one of the housing and the cover is comprised of a material selected from the group consisting of polyvinyl chloride, polycarbonate, and metal.

15. The container of claim 12 wherein the first hinge and the second hinge are living hinges.

16. The container of claim 12 also comprising a plurality of ribs attached to the base of the housing.

17. The container of claim 12 wherein the cover is comprised of a base having two spaced apart side walls and wherein a pair of arms are provided in each of the first wall and the second wall and the spaced apart sidewalls each have a pair of slots, one slot of each side wall containing an arm on the first side wall and the second slot on each side wall containing an arm from the second wall.

18. The container of claim 12 wherein the housing and the cover together define a cavity of sufficient size to hold window covering hardware of the type that is shipped with but not attached to a window blind.

19. The container of claim 12 wherein the tubular body is made of a flexible plastic.

20. A container having removable end caps comprising:
a tubular body sized to hold a window covering and having a first open end and a second open end;
a first end cap removably inserted into and covering the first open end of the tubular body;
a second end cap removably inserted into and covering the second open end of the tubular body;
wherein at least one of the first end cap and the second end cap is comprised of a housing and a cover removably attached to the housing, the housing and cover configured to define a cavity of sufficient size to hold window covering hardware of the type that is shipped with but not attached to a window blind.

21. The container of claim 20 wherein at least one of the housing and the cover is comprised of a material selected from the group consisting of polyvinyl chloride, polycarbonate and metal.
